(19) United States
(12) Patent Application Publication
(10) Pub. No.: US 2024/0251478 A1
(43) Pub. Date: Jul. 25, 2024

(54) METHOD AND APPARATUS FOR PROCESSING MULTICAST SERVICE, AND NETWORK DEVICE

(71) Applicant: VIVO MOBILE COMMUNICATION CO., LTD., Dongguan (CN)

(72) Inventor: Zhenhua XIE, Dongguan (CN)

(73) Assignee: VIVO MOBILE COMMUNICATION CO., LTD., Dongguan (CN)

(21) Appl. No.: 18/625,340

(22) Filed: Apr. 3, 2024

Related U.S. Application Data
(63) Continuation of application No. PCT/CN2022/123797, filed on Oct. 8, 2022.

(30) Foreign Application Priority Data
Oct. 8, 2021 (CN) 202111171937.1

(51) Int. Cl. H04W 76/40; H04W 48/20; H04W 68/02; H04W 76/20

(52) U.S. Cl. CPC H04W 76/40; H04W 48/20; H04W 68/02; H04W 76/20

(57) ABSTRACT

This application discloses a method and an apparatus for processing a multicast service, and a network device. The method includes: A first core network function sends first area information to a second core network function when a multicast session or service is active. The first area information is used for at least one of the following processes: the second core network function selects a first terminal; the second core network function sends information about a first terminal to the first core network function; the second core network function selects a paging area; or the second core network function selects a first radio access network (RAN) node.

### CROSS-REFERENCE TO RELATED APPLICATIONS

This application is a continuation of International Application No. PCT/CN2022/123797, filed Oct. 8, 2022, which claims priority to Chinese Patent Application No. 202111171937.1, filed Oct. 8, 2021. The entire contents of each of the above-referenced applications are expressly incorporated herein by reference.

### TECHNICAL FIELD

This application relates to the field of communication technologies, and in particular, to a method and an apparatus for processing a multicast service, and a network device.

### BACKGROUND

In a case that a status of a Multi-cast Broadcast Service (MBS) or session is updated to “active”, an Access and Mobility Management Function (AMF) pages all User Equipment (UE, also referred to as a terminal). Consequently, a UE that is no longer in a service area is also notified of “active”, causing an unnecessary signaling process and increasing signaling overheads.

### SUMMARY

Embodiments of this application provide a method and an apparatus for processing a multicast service, and a network device.

According to a first aspect, a method for processing a multicast service is provided, including:
sending, by a first core network function, first area information to a second core network function in a case that a multicast session or service is active.

The first area information is used for at least one of the following processes:
the second core network function selects a first terminal;
the second core network function sends information about a first terminal to the first core network function;
the second core network function selects a paging area; or
the second core network function selects a first radio access network RAN node.

According to a second aspect, a method for processing a multicast service is provided, including:
receiving, by a second core network function, first area information; and
performing, by the second core network function, a first operation based on the first area information.

The first operation includes at least one of the following:
selecting a first terminal;
sending information about a first terminal to a first core network function;
selecting a paging area; or
selecting a first radio access network RAN node.

According to a third aspect, an apparatus for processing a multicast service is provided, including:
a first sending module, configured to send first area information to a second core network function in a case that a multicast session or service is active.

The first area information is used for at least one of the following processes:
the second core network function selects a first terminal;
the second core network function sends information about a first terminal to a first core network function;
the second core network function selects a paging area; or
the second core network function selects a first radio access network RAN node.

According to a fourth aspect, an apparatus for processing a multicast service is provided, including:
a first receiving module, configured to receive first area information; and
a first processing module, configured to perform a first operation based on the first area information.

The first operation includes at least one of the following:
selecting a first terminal;
sending information about a first terminal to a first core network function;
selecting a paging area; or
selecting a first radio access network RAN node.

According to a fifth aspect, a network device is provided, and the network device includes a processor, a memory, and a program or instructions stored in the memory and capable of running on the processor. When the program or the instructions are executed by the processor, the steps of the method according to the first aspect or the second aspect are implemented.

According to a sixth aspect, a network device is provided, and the network device includes a processor and a communication interface. The communication interface is configured to send first area information to a second core network function in a case that a multicast session or service is active. The first area information is used for at least one of the following processes: the second core network function selects a first terminal; the second core network function sends information about a first terminal to a first core network function; the second core network function selects a paging area; or the second core network function selects a first radio access network RAN node. In some embodiments, the communication interface is configured to receive first area information, and the processor is configured to perform a first operation based on the first area information. The first operation includes at least one of the following: selecting a first terminal; sending information about a first terminal to a first core network function; selecting a paging area;

or selecting a first radio access network RAN node.

According to a seventh aspect, a readable storage medium is provided, and the readable storage medium stores a program or instructions. When the program or the instructions are executed by a processor, the steps of the method according to the first aspect or the second aspect are implemented.

According to an eighth aspect, a chip is provided, and the chip includes a processor and a communication interface. The communication interface is coupled to the processor, and the processor is configured to run a program or instructions to implement the method according to the first aspect or the second aspect.

According to a ninth aspect, a computer program product is provided. The computer

program product is stored in a non-transitory storage medium, and the computer program product is executed by at least one processor to implement the steps of the method according to the first aspect or the second aspect.

According to a tenth aspect, a network device is provided, and configured to perform the steps of the method according to the first aspect or the second aspect.

In embodiments of this application, a first core network function sends first area information to a second core network function in a case that a multicast session or service is active. The first area information is used for at least one of the following processes: the second core network function selects a first terminal; the second core network function sends information about a first terminal to the first core network function; the second core network function selects a paging area; or the second core network function selects a first radio access network RAN node. In this way, a UE to which an activation notification needs to be sent can be selected based on the first area information, so that the activation notification is sent only to the corresponding UE but not to all UEs, to reduce signaling overheads and reduce disturbance to the UEs.

### BRIEF DESCRIPTION OF DRAWINGS

FIG. 1 is a diagram of a structure of a communication system to which embodiments of this application can be applied;

FIG. 2 is a schematic flowchart 1 of a method for processing a multicast service according to an embodiment of this application;

FIG. 3 is a schematic flowchart 2 of a method for processing a multicast service according to an embodiment of this application;

FIG. 4 is a schematic diagram 1 of a module of an apparatus for processing a multicast service according to an embodiment of this application;

FIG. 5 is a schematic diagram 2 of a module of an apparatus for processing a multicast service according to an embodiment of this application;

FIG. 6 is a block diagram of a structure of a communication device according to an embodiment of this application; and

FIG. 7 is a block diagram of a structure of a network device according to an embodiment of this application.

### DETAILED DESCRIPTION

The following clearly describes technical solutions in embodiments of this application with reference to accompanying drawings in embodiments of this application. Apparently, the described embodiments are some but not all of embodiments of this application. All other embodiments obtained by a person of ordinary skill in the art based on embodiments of this application shall fall within the protection scope of this application.

The terms “first”, “second”, and the like in this specification and claims of this application are used to distinguish between similar objects instead of describing a specific order or sequence. It should be understood that, terms used in such a way are interchangeable in proper circumstances, so that embodiments of this application can be implemented in an order other than the order illustrated or described herein. Objects classified by “first” and “second” are usually of a same type, and the quantity of objects is not limited. For example, there may be one or more first objects. In addition, in the specification and the claims, “and/or” indicates at least one of connected objects, and a character “/” generally indicates an “or” relationship between associated objects.

It should be noted that, technologies described in embodiments of this application are not limited to a Long Term Evolution (LTE)/LTE-Advanced (LTE-A) system, and can also be used in other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), and another system. The terms “system” and “network” in embodiments of this application may be used interchangeably. The described technologies can be applied to the systems and the radio technologies mentioned above as well as to other systems and radio technologies. A New Radio (NR) system is described below for an illustration purpose, and the term NR is used in most of the descriptions, but these technologies can also be used in an application other than an NR system application, for example, a 6^{th} Generation (6G) communication system.

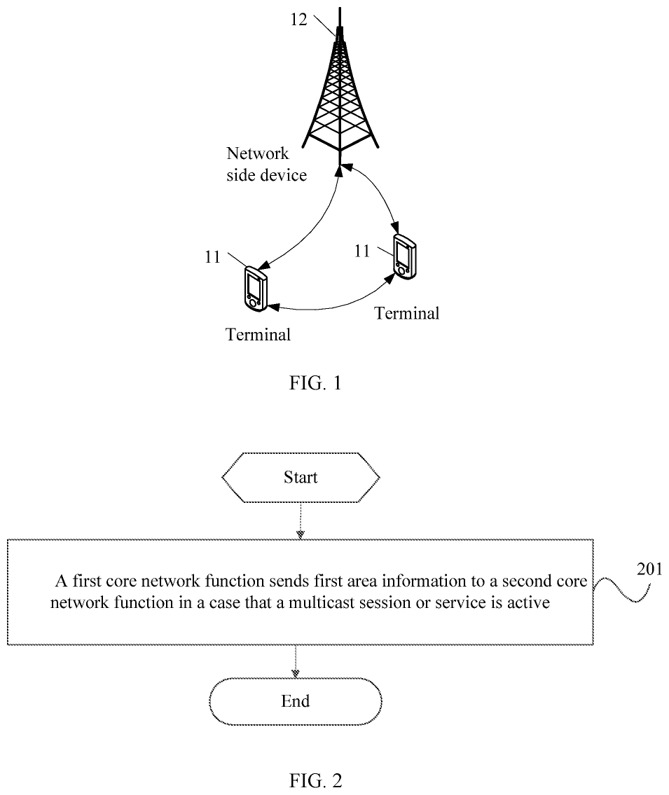

FIG. 1 is a diagram of a structure of a wireless communication system to which embodiments of this application can be applied. The wireless communication system includes a terminal 11 and a network side device 12. The terminal 11 may also be referred to as a terminal device or a User Equipment (UE). The terminal 11 may be a terminal side device such as a mobile phone, a tablet personal computer, a laptop computer or a notebook computer, a personal digital assistant ( ), a palmtop computer, a netbook, an ultra-mobile personal computer (UMPC), a mobile Internet device (MID), an augmented reality (AR)/virtual reality (VR) device, a robot, a wearable device, a vehicle user equipment (VUE), a pedestrian user equipment (PUE), or a smart home (a home device that has a wireless communication function, for example, a refrigerator, a television, a washing machine, or furniture). The wearable device includes a smart watch, a smart band, a smart headset, smart glasses, smart jewelry (a smart hand bracelet, a smart hand chain, a smart finger ring, a smart necklace, a smart ankle bracelet, a smart ankle chain, or the like), a smart wrist strap, smart dress, a game machine, or the like. It should be noted that, a specific type of the terminal 11 is not limited in embodiments of this application. The network side device 12 may be a base station or a core network device. The base station may be referred to as a node B, an evolved node B, an access point, a base transceiver station (BTS), a radio base station, a radio transceiver, a basic service set (BSS), an extended service set (ESS), a NodeB, an evolved NodeB (eNB), a home NodeB, a home evolved NodeB, a wireless local area network (WLAN) access point, a wireless fidelity (WiFi) node, a transmitting receiving point (TRP), or another appropriate term in the art. As long as a same technical effect is achieved, the base station is not limited to a specified technical term. It should be noted that, in embodiments of this application, only a base station in the NR system is used as an example, but a specific type of the base station is not limited.

With reference to the accompanying drawings, a method for processing a multicast service provided in embodiments of this application is described in detail through some embodiments and application scenarios.

As shown in FIG. 2, an embodiment of this application provides a method for processing a multicast service, and the method includes the following steps.

Step 201: A first core network function sends first area information to a second core network function in a case that a multicast session or service is active.

The first area information is area information related to activation of the multicast service or session.

In this embodiment of this application, the first core network function may be a Session Management Function (SMF). The second core network function is an AMF.

The first area information may be area information of the multicast service or the multicast session after update.

In this embodiment of this application, in a case that the multicast session or service is active, the SMF sends the first area information to the AMF. The first area information is area information related to activation of the multicast service or session. In this way, an activation range corresponding to the multicast session or service can be determined based on the first area information, so that the AMF can send an activation notification to a UE in the corresponding range based on the area information but not to all UEs, to reduce signaling overheads and reduce disturbance to the UEs.

In some embodiments, the first area information includes at least one of the following:
at least one cell identity; or
at least one tracking area identity.

In some embodiments, the first area information is used for at least one of the following processes:
the second core network function selects a first terminal;
the second core network function sends information about a first terminal to the first core network function;
the second core network function selects a paging area; or
the second core network function selects a first Radio Access Network (RAN) node.

In some embodiments of this application, the first RAN node may be a RAN node in a paging area. The second core network function selects the first RAN node to send a message, for example, send a paging message.

In some embodiments, the first terminal is located in an area indicated by the first area information and includes at least one of the following:
a UE in a connected state; or
a UE in a Radio Resource Control (RRC) inactive state.

According to the method in embodiments of this application, in a case that the multicast session or service is active, the first core network function sends the first area information to the second core network function. The activation range corresponding to the multicast session or service can be determined based on the first area information, so that the AMF can send the activation notification to the UE in the corresponding range based on the area information but not to all UEs, to reduce signaling overheads and reduce disturbance to the UEs.

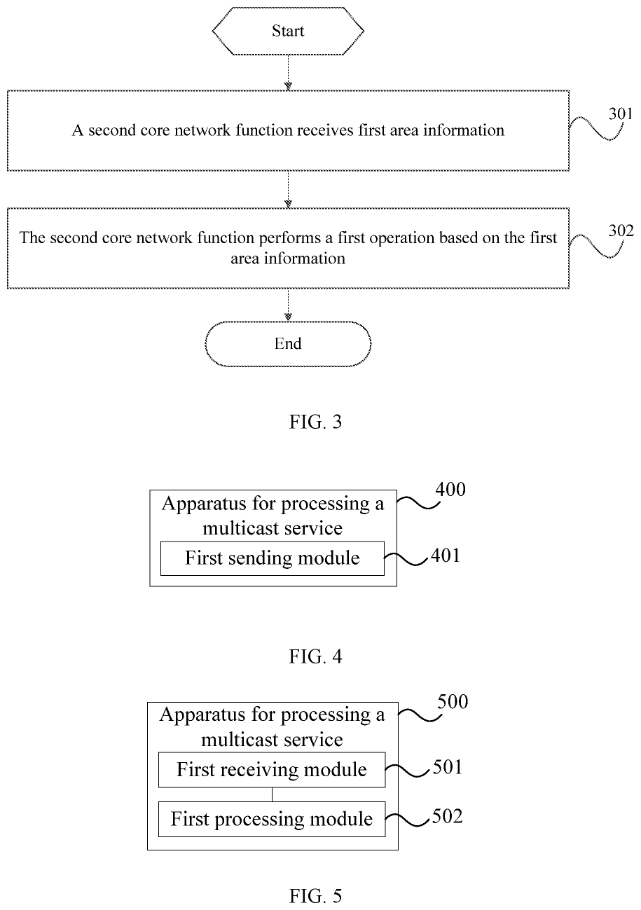

As shown in FIG. 3, an embodiment of this application further provides a method for processing a multicast service, and the method includes the following steps.

Step 301: A second core network function receives first area information.

Step 302: The second core network function performs a first operation based on the first area information.

The first operation includes at least one of the following:
selecting a first terminal;
sending information about a first terminal to a first core network function;
selecting a paging area; or
selecting a first radio access network RAN node.

The first core network function may be a Session Management Function (SMF). The second core network function is an AMF.

In some embodiments, the first area information includes at least one of the following:
at least one cell identity; or
at least one tracking area identity.

In some embodiments, the first terminal is located in an area indicated by the first area information and includes at least one of the following:
a UE in a connected state; or
a UE in a radio resource control RRC inactive state.

In this embodiment of this application, the second core network function receives the first area information, and based on the first area information, selects the paging area, selects the first terminal, or the like, so that the second core network function can send an activation notification to a corresponding UE based on the first area information but not to all UEs, to reduce signaling overheads and reduce disturbance to the UEs.

It should be noted that, the method for processing the multicast service provided in embodiments of this application may be performed by an apparatus for processing a multicast service, or a control module that is in the apparatus for processing the multicast service and that is configured to perform the method for processing the multicast service. In embodiments of this application, that the apparatus for processing the multicast service performs the method for processing the multicast service is used as an example to describe the apparatus for processing the multicast service provided in embodiments of this application.

As shown in FIG. 4, an embodiment of this application provides an apparatus 400 for processing a multicast service, including:
a first sending module 401, configured to send first area information to a second core network function in a case that a multicast session or service is active.

The first area information is used for at least one of the following processes:
the second core network function selects a first terminal;
the second core network function sends information about a first terminal to a first core network function;
the second core network function selects a paging area; or
the second core network function selects a first radio access network RAN node.

In some embodiments, the apparatus in this embodiment of this application further includes:
a determining module, configured to determine the first area information.

In some embodiments, the first area information includes at least one of the following:
at least one cell identity; or
at least one tracking area identity.

In some embodiments, the first terminal is located in an area indicated by the first area information and includes at least one of the following:
a UE in a connected state; or
a UE in a radio resource control RRC inactive state.

In this embodiment of this application, in a case that the multicast session or service is active, the first core network function sends the first area information to the second core network function. The first area information is used for at least one of the following processes: the second core network function selects the first terminal; the second core network function sends the information about the first terminal to the first core network function; the second core network function selects the paging area; or the second core network function selects the first radio access network RAN node. In this way, a UE to which an activation notification needs to be sent can be selected based on the first area information, so that the activation notification is sent only to the corresponding UE but not to all UEs, to reduce signaling overheads and reduce disturbance to the UEs.

As shown in FIG. 5, an embodiment of this application further provides an apparatus 500 for processing a multicast service, including:
a first receiving module 501, configured to receive first area information; and
a first processing module 502, configured to perform a first operation based on the first area information.

The first operation includes at least one of the following:
selecting a first terminal;
sending information about a first terminal to a first core network function;
selecting a paging area; or
selecting a first radio access network RAN node.

In some embodiments, the first area information includes at least one of the following:
at least one cell identity; or
at least one tracking area identity.

In some embodiments, the first terminal is located in an area indicated by the first area information and includes at least one of the following:
a UE in a connected state; or
a UE in a radio resource control RRC inactive state.

The apparatus in this embodiment of this application receives the first area information, and based on the first area information, selects the paging area, selects the first terminal, or the like, so that can send an activation notification to a corresponding UE based on the first area information but not to all UEs, to reduce signaling overheads and reduce disturbance to the UEs.

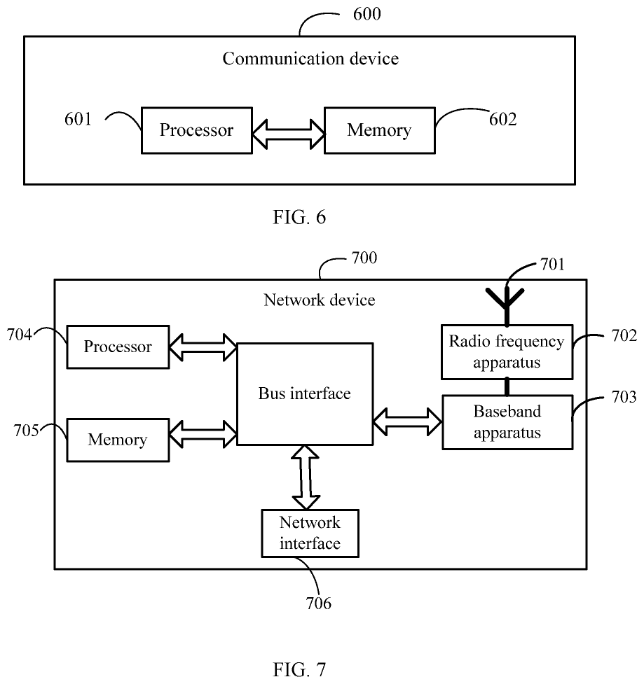

As shown in FIG. 6, an embodiment of this application further provides a communication device 600, including a processor 601, a memory 602, and a program or instructions stored in the memory 602 and capable of running on the processor 601. When the communication device is a first core network function, and the program or the instructions are executed by the processor 601, the processes of the embodiment of the method for processing the multicast service applied to the first core network function are implemented, and a same technical effect can be achieved. When the communication device is a second core network function, and the program or the instructions are executed by the processor 601, the processes of the embodiment of the method for processing the multicast service applied to the second core network function are implemented, and a same technical effect can be achieved. To avoid repetition, details are not described herein again.

An embodiment of this application further provides a network device. The network device may be the foregoing first core network function or the foregoing second core network function. The network device includes a processor and a communication interface. When the network device is the first core network function, the communication interface is configured to send first area information to a second core network function in a case that a multicast session or service is active. The first area information is used for at least one of the following processes: the second core network function selects a first terminal; the second core network function sends information about a first terminal to the first core network function; the second core network function selects a paging area; or the second core network function selects a first radio access network RAN node. When the network device is the second core network function, the communication interface is configured to receive first area information, and the processor is configured to perform a first operation based on the first area information. The first operation includes at least one of the following: selecting a first terminal; sending information about a first terminal to a first core network function; selecting a paging area; or selecting a first radio access network RAN node.

An embodiment of this application further provides a network device. In some embodiments, the network device is the foregoing first core network function or the foregoing second core network function. As shown in FIG. 7, the network device 700 includes an antenna 701, a radio frequency apparatus 702, and a baseband apparatus 703. The antenna 701 is connected to the radio frequency apparatus 702. In an uplink direction, the radio frequency apparatus 702 receives information through the antenna 701, and sends the received information to the baseband apparatus 703 for processing. In a downlink direction, the baseband apparatus 703 processes to-be-sent information, and sends the information to the radio frequency apparatus 702. The radio frequency apparatus 702 processes the received information, and then sends the information through the antenna 701.

The radio frequency apparatus 702 may be located in the baseband apparatus 703. In the foregoing embodiments, the method performed by the network device may be implemented in the baseband apparatus 703. The baseband apparatus 703 includes a processor 704 and a memory 705.

For example, the baseband apparatus 703 may include at least one baseband board, and a plurality of chips are disposed on the baseband board. As shown in FIG. 7, one chip is, for example, the processor 704, which is connected to the memory 705, so as to invoke a program in the memory 705 to perform the operations of the first core network function or the second core network function shown in the foregoing method embodiments.

The baseband apparatus 703 may further include a network interface 706, configured to exchange information with the radio frequency apparatus 702. The interface is, for example, a common public radio interface (CPRI).

The network device (the first core network function or the second core network function) in this embodiment of this application further includes instructions or a program stored in the memory 705 and capable of running on the processor 704. The processor 704 invokes the instructions or the program in the memory 705 to perform the method performed by the modules shown in FIG. 4 or FIG. 5, and a same technical effect is achieved. To avoid repetition, details are not described herein again.

An embodiment of this application further provides a readable storage medium. The readable storage medium may be volatile or may be non-volatile. The readable storage medium stores a program or instructions. When the program or the instructions are executed by a processor, the processes of the embodiment of the method for processing the multicast service are implemented, and a same technical effect can be achieved. To avoid repetition, details are not described herein again.

The processor is a processor in the terminal in the foregoing embodiments. The readable storage medium includes a computer-readable storage medium, such as a Read-Only Memory (ROM), a Random Access Memory (RAM), a magnetic disk, or an optical disc.

An embodiment of this application further provides a chip, and the chip includes a processor and a communication interface. The communication interface is coupled to the processor, and the processor is configured to run a program or instructions to implement the processes of the embodiment of the method for processing the multicast service, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application further provides a computer program product. The computer program product is stored in a non-transitory storage medium, and the computer program product is executed by at least one processor to implement the processes of the embodiment of the method for processing the multicast service, and a same technical effect can be achieved. To avoid repetition, details are not described herein again.

An embodiment of this application further provides a network device, configured to perform the processes of the embodiment of the method for processing the multicast service, and a same technical effect can be achieved. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to such process, method, article, or apparatus. In absence of more constraints, an element defined by “includes a . . . ” does not preclude the existence of other identical elements in the process, method, article, or apparatus that includes the element. In addition, it should be noted that, the scope of the method and the apparatus in the implementations of this application is not limited to performing functions in an illustrated or discussed sequence, and may further include performing functions in a basically simultaneous manner or in a reverse sequence based on the involved functions. For example, the described method may be performed in an order different from the described order, and various steps may be added, omitted, or combined. In addition, features described with reference to some examples may be combined in other examples.

Based on the descriptions of the foregoing implementations, a person skilled in the art may understand that the method in the foregoing embodiments may be implemented by software in addition to a necessary universal hardware platform or by hardware only. In most circumstances, the former is a preferred implementation. Based on such an understanding, the technical solutions of this application essentially or a part contributing to the prior art may be implemented in a form of a computer software product. The computer software product is stored in a storage medium (such as a ROM/RAM, a magnetic disk, or an optical disc), and includes several instructions for instructing a terminal (which may be a mobile phone, a computer, a server, a network device, or the like) to perform the method described in embodiments of this application.

Embodiments of this application are described above with reference to the accompanying drawings, but this application is not limited to the foregoing implementations, and the implementations are only illustrative and not restrictive. Under the enlightenment of this application, a person of ordinary skill in the art can make many forms without departing from the purpose of this application and the protection scope of the claims, all of which fall within the protection of this application.

1. A method for processing a multicast service, comprising:
sending, by a first core network function, first area information to a second core network function when a multicast session or service is active,
wherein the first area information is used for at least one of the following processes:
the second core network function selects a first terminal;
the second core network function sends information about a first terminal to the first core network function;
the second core network function selects a paging area; or
the second core network function selects a first radio access network (RAN) node.

2. The method according to claim 1, wherein the first area information comprises at least one of the following:
at least one cell identity; or
at least one tracking area identity.

3. The method according to claim 1, wherein the first terminal is located in an area indicated by the first area information and comprises at least one of the following:
a UE in a connected state; or
a UE in a radio resource control (RRC) inactive state.

4. The method according to claim 1, wherein the first RNA node comprises RAN nodes within the paging area; or
the first RNA node is used to send a paging message.

5. The method according to claim 1, wherein the first core network function comprises a Session Management Function (SMF), and the second core network function comprises an Access and Mobility Management Function (AMF).

6. A method for processing a multicast service, comprising:
receiving, by a second core network function, first area information; and
performing, by the second core network function, a first operation based on the first area information,
wherein the first operation comprises at least one of the following:
selecting a first terminal;
sending information about a first terminal to a first core network function;
selecting a paging area; or
selecting a first radio access network (RAN) node.

7. The method according to claim 6, wherein the first area information comprises at least one of the following:
at least one cell identity; or
at least one tracking area identity.

8. The method according to claim 6, wherein the first terminal is located in an area indicated by the first area information and comprises at least one of the following:
a UE in a connected state; or
a UE in a radio resource control (RRC) inactive state.

9. The method according to claim 6, wherein the first RNA node comprises RAN nodes within the paging area; or
the first RNA node is used to send a paging message.

10. The method according to claim 6, wherein the first core network function comprises a Session Management Function (SMF), and the second core network function comprises an Access and Mobility Management Function (AMF).

11. A first core network function, comprising: a memory storing a computer program; and a processor coupled to the memory and configured to execute the computer program to perform operations comprising:
sending, by the first core network function, first area information to a second core network function when a multicast session or service is active,
wherein the first area information is used for at least one of the following processes:
the second core network function selects a first terminal;
the second core network function sends information about a first terminal to the first core network function;
the second core network function selects a paging area; or
the second core network function selects a first radio access network (RAN) node.

12. The first core network function according to claim 11, wherein the first area information comprises at least one of the following:
at least one cell identity; or
at least one tracking area identity.

13. The first core network function according to claim 11, wherein the first terminal is located in an area indicated by the first area information and comprises at least one of the following:
a UE in a connected state; or
a UE in a radio resource control (RRC) inactive state.

14. The first core network function according to claim 11, wherein the first RNA node comprises RAN nodes within the paging area; or
the first RNA node is used to send a paging message.

15. The first core network function according to claim 11, wherein the first core network function comprises a Session Management Function (SMF), and the second core network function comprises an Access and Mobility Management Function (AMF).

16. A second core network function, comprising: a memory storing a computer program; and a processor coupled to the memory and configured to execute the computer program to perform the method according to claim 6.

17. The second core network function according to claim 16, wherein the first area information comprises at least one of the following:
at least one cell identity; or
at least one tracking area identity.

18. The second core network function according to claim 16, wherein the first terminal is located in an area indicated by the first area information and comprises at least one of the following:
a UE in a connected state; or
a UE in a radio resource control (RRC) inactive state.

19. The second core network function according to claim 16, wherein the first RNA node comprises RAN nodes within the paging area; or
the first RNA node is used to send a paging message.

20. The second core network function according to claim 16, wherein the first core network function comprises a Session Management Function (SMF), and the second core network function comprises an Access and Mobility Management Function (AMF).
